(19) United States
(12) Patent Application Publication
(10) Pub. No.: US 2002/0011311 A1
(43) Pub. Date: Jan. 31, 2002

(54) In-line egg labelling system

(76) Inventors: Steve Carignan, Montreal (CA); Luc Trottier, Repentigny (CA)

Correspondence Address: Gaetan Prince, GOUDREAU GAGE DUBUC, The Stock Exchange Tower, Suite 3400, 800 Place Victoria, Montreal, QC, H4Z 1E9, CA

(21) Appl. No.: 09/915,449

(22) Filed: Jul. 27, 2001

(30) Foreign Application Priority Data
Jul. 28, 2000 (CA) 2,315,267

(51) Int. Cl. B32B 31/00

(52) U.S. Cl. 156/350; 156/556; 156/566

(57) ABSTRACT

There is provided an in-line egg labelling system for applying a label on eggs travelling into grippers of a conveyer, such as a chain conveyer, said system comprising at least one labelling device mounted beneath said conveyor and provided with a label applying arm for applying a label on an exposed area of an egg surface, preferably on a generally downwardly facing area thereof. The conveyer is preferably part of an egg packing system comprising a packing controller. The labelling system further comprises a computerised labelling control system and a user interface for the automatic individual selection of the eggs to be labelled on the basis of at least one user set parameter and one input parameter communicated by the packing controller to indicate the destination of each egg. In a preferred embodiment of the invention, the operation is based on two user set parameters, which are a) the destinations for which eggs are to be labelled and 2) the desired ratio for the number of labelled eggs/number of packed eggs per destination. The labelling controller and interface further perform generation and output of statistical data for user information and follow-up.

### BACKGROUND OF THE INVENTION

1. Field of the Invention

The present invention relates to labelling systems and more specifically to a system for applying labels on eggs individually carried on a conveyer running at high speed. The invention is particularly suited for applying high quality multicolor information such as advertising information on the shell of consumer eggs, without the risk of contaminating the egg with printing inks.

2. Brief Description of the Prior Art

Advertising vehicles are developing continuously, in an attempt to find new and more efficient means to attract consumers' attention and communicate information. Food products are bought, manipulated and used on a daily basis in every family. Therefore, they can be a powerful means for communicating information. Packages are often used to carry miscellaneous printed information and communicate it to the members of several families—missing people on milk bottles for instance. Some bulk food products such as fruits and vegetables are also carrying information on small labels, which is usually related to the product itself or to its producer. Eggs are manipulated in every household almost if not every day and their white shells represent a powerful advertising vehicle. However, applying good quality advertising information on eggs represents a technical challenge.

Indeed, ink jet printers are currently used to apply written information such as packing date or lot number on egg shells. Such a system is described for example in U.S. Pat. No. 4,843,958 delivered to Egosi in 1989. However, to avoid egg contamination, vegetable based inks must be used, which are available in a very limited selection of pale colors. Moreover, the egg shape and its high relative speed with respect to the printer yields distortion in droplet distribution and poor definition. Attractive advertising requires a high definition multicolor process and thus can not be applied by direct printing with existing technologies.

Therefore, application of a pre-printed label on egg shells must be considered. The only known reference to date to such a process has been made in a Japanese publication No JP10101048, by Nanbu in 1998. The publication contemplates a labelling system for the printing and application of labels bearing information such as the packing date on the shell of eggs contained in packages carried on belt conveyers. Nevertheless, anyone of ordinary skill in the art knows that since one of the grippers of an egg sorting chain conveyer such as in a Diamond Systems (U. K. manufacturer) egg grading and packing system (two or three grippers are generally assembled side by side per conveyer longitudinal position) usually feeds ten or more packing machines, packages containing twelve eggs on two rows are travelling at least ten times slower than incoming eggs in term of the linear translation speed of an egg. Should one wish to selectively apply labels on eggs packed by any combination of packing machines with the Nanby system, one labelling apparatus would have to be bought and installed for each packing machine.

The concept contemplated herein rather aims at selectively labelling eggs as they pass on the main incoming chain conveyer as a function of their destination packing machine. Indeed, at a given point in time, eggs of a given packing machine are shipped to a specific distributor, retailer or user (client) and each egg, according to its specifications, is directed to a specific packing machine. Obviously, for advertising purposes, not every client is subject to receiving labelled eggs. For example, retailers such as grocery stores should be provided with labelled eggs and commercial suppliers and industrial users should not.

The system should then be installed on the main conveyer, be informed of the destination of the egg travelling in front of it and be fast enough to apply the label, if required, on the egg travelling at more than 200 feet per minute. Furthermore, besides providing unlimited flexibility, such a system would allow significant cost savings if one system with one labelling head per parallel longitudinal egg row can serve a main conveyer supplying ten to fourteen packing stations per row with eggs of different sizes. Also, typical lines are equipped with ink jet printers printing a date or lot number on the side of each egg through a window provided on the sides of the grippers. The label should then be applied on the underside of the eggs, as viewed from the side of the chain conveyer. Moreover, the present invention contemplates a retrofit compliant system, which can be easily installed on existing egg grading and packing lines such as provided by DIAMOND SYSTEMS with a strict minimum of modifications and within normal limited shut down periods in order to cause no production loss. Since these lines are not designed to include a labelling operation, important space problems are encountered and must be addressed.

The above examples show that no egg labelling system exists that provides the flexibility and speed as required for providing egg packing centers with systems capable of selectively applying labels on the shell of eggs travelling on the main chain conveyer, while allowing retrofitting to existing installations. The devices of the prior art are lacking important features to provide a practical and economical solution for the application of high quality advertising information on egg shells.

There is thus a need for a novel in-line egg labelling system that can be installed on existing egg packing lines, for the selective application of advertising or other types of labels on egg shells.

### OBJECT OF THE INVENTION

The present invention provides an in-line egg labelling system for applying information bearing labels on egg shells, which overcomes the limitations and drawbacks of the above mentioned solutions of the prior art, and more specifically:

a first object of the instant invention is to provide an in-line egg labelling system comprising compact labelling devices that can be installed underneath an existing egg transporting chain conveyer and between two consecutive packing stations of an egg packing system;

a second object of the present invention is to provide an in-line egg labelling system featuring sufficiently high speed and feed rate to selectively label any or all of the eggs travelling at a given position in the grippers of a chain conveyer, up to a linear speed exceeding 200 feet per minute for a capacity greater than 50,000 labelled eggs per hour per label applying device;

a third object of the present invention is to provide an in-line egg labelling system having the capability to label all of the eggs on each gripper row, and of the egg carried by the conveyer by using one compact label applying device for each of the two or three rows of grippers;

a fourth object of the present invention is to provide an in-line egg labelling system having the flexibility to apply or not a label on an egg, depending on the destination of said egg and on a desired ratio of labelled eggs/total eggs packed per destination on which labelling is carried out, according to previously user set data;

a fifth object of the present invention is to provide an in-line egg labelling system complying with the shape and difference in size of the travelling eggs to repeatedly provide good adhesion and neat application of the label;

another object of the present invention is to provide an in-line egg labelling system providing statistical data on the number of labelled eggs per period of time and per destination, as well as other operational data for management purposes such as billing, label inventory and maintenance;

a further object of the present invention is to provide an in-line egg labelling system able to successfully apply a label on the underside of eggs, regardless of the surface conditions of the eggs fed on the chain conveyer;

a still further object of the present invention is to provide an in-line egg labelling system which is reliable and economical and does not interfere with the normal operations of egg grading and packing centers;

### SUMMARY OF THE INVENTION

More specifically, in accordance with the invention as broadly claimed, there is provided an in-line egg labelling system for applying a label on eggs travelling into grippers of a conveyer, such as a chain conveyer, said system comprising at least one labelling device mounted beneath said conveyor and provided with a label applying arm for applying a label on an exposed area of an egg surface, preferably on a generally downwardly facing area thereof. The conveyer is preferably part of an egg packing system comprising a packing controller. The labelling system further comprises a computerised labelling control system and a user interface for the automatic individual selection of the eggs to be labelled on the basis of at least one user set parameter and one input parameter communicated by the packing controller to indicate the destination of each egg. In a preferred embodiment of the invention, the operation is based on two user set parameters, which are a) the destinations for which eggs are to be labelled and 2) the desired ratio for the number of labelled eggs/number of packed eggs per destination. The labelling controller and interface further perform generation and output of statistical data for user information and follow-up.

### BRIEF DESCRIPTION OF THE DRAWINGS

FIG. 1 is a side elevation view of a preferred embodiment of the in-line egg labelling system of the present invention showing a labelling device installed beneath the chain conveyer of an egg packing system and applying labels on the underside of the eggs carried in the grippers of the conveyer.

FIG. 2 is a block diagram representation of the components of the in-line egg labelling system according to the present invention, in co-operation with elements of an existing egg packing system.

Similar reference numerals refer to similar parts throughout the various Figures.

### DETAILED DESCRIPTION OF THE DRAWINGS

A preferred embodiment of the in-line egg labelling system according to the present invention will now be described in detail referring to the appended drawings.

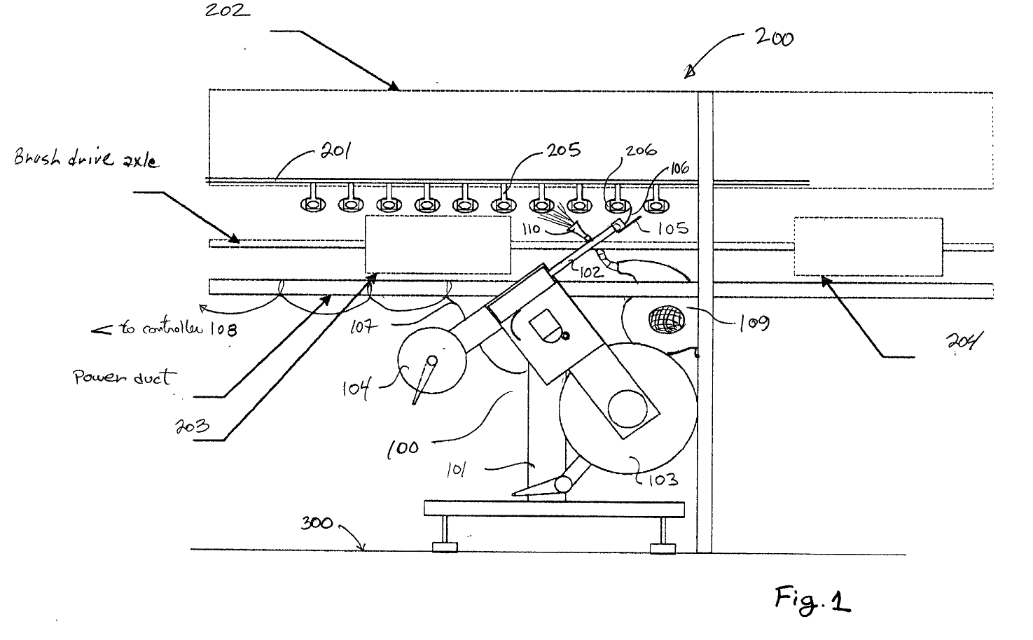

Referring to FIG. 1, there is illustrated a label applying device generally identified by numeral 100, co-operating with an existing egg sorting and packing system 200 partly illustrated to show the portion extending from the third packing station represented by the transfer brush 203, to the fourth packing station represented by transfer brush 204. The egg sorting system 200 comprises a chain conveyer 201 protected by an enclosure 202 from which egg retaining grippers 205 are downwardly projecting. Eggs 206 are being carried by said grippers 205 from a section of the egg sorting system 200 upstream of the illustrated portion where cleaning, weighting, inspection and grading are taking place. Station one is receiving rejected eggs and the space between the first and second stations is occupied by the ink jet printers usually used for printing a date or lot number on the eggs 206 to be packed downstream. Therefore, the nearest location to the beginning of the packing section where labelling devices can be installed is between the third and fourth packing stations 203 and 204 respectively. However, the space is very limited and no existing standard labelling machine could fit in that space.

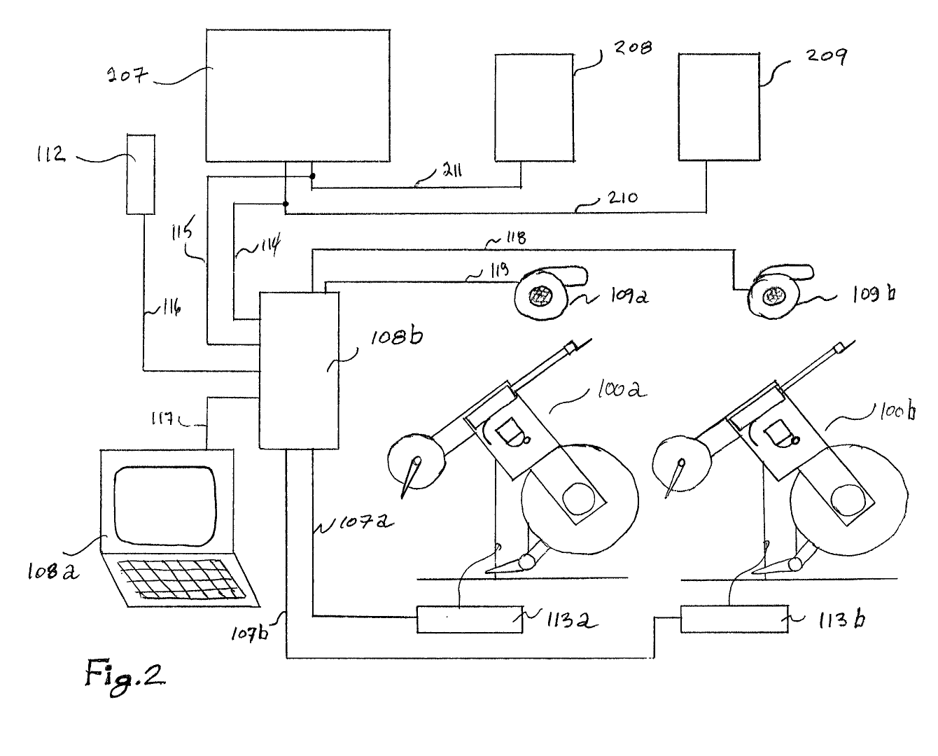

The labelling device 100 is a stand alone unit and is mounted on its own base 101 supported on the floor 300. Said labelling device 100 is a modified version of a high speed labelling machine such as the HERMA 300 MODULAR SYSTEM provided by the Germany based firm HERMA Labelling Systems, and comprises a narrow elongated arm 102 to bring the label from a feed roll 103 to the lower surface of the target egg 206. Labels in feed roll 103 are supported on a paper backing ribbon collected on roll 104 once the labels 106 have been peeled off and applied to egg shells 206. In order to fit in the space available and reach the surface of eggs 206, arm 102 of the labelling device 100 has been extended and narrowed to a width lower than the diameter of a typical egg and mounted on a special bracket providing an upward and an inward inclination as needed. Also, the distal end of arm 102 is provided with a smoothing brush, roller, pad or the like 105, to gently spread and stick label 106 on the surface of eggs 206. The labelling device further comprises a connecting cable 107 communicating control signals from the remote labelling control system 108, comprised of a microcomputer 108a and an interface module 108b, as shown on FIG. 2.

As the incoming eggs have just been washed in water, some moisture is usually still present at the surface of the shell when an egg reaches the labelling station. Therefore, water base adhesive is used on the labels and the thickness and formulation of the adhesive layer is carefully adapted to provide good adhesion of the label to the surface. Nevertheless, to assure that the surface of the incoming eggs is as dry as possible, an air blower 109 provided with a nozzle 110 located just upstream of the labelling device, projects air at high speed toward the lower surface of the travelling eggs to dry the labelling area by evaporation and evacuation of the water. An air drying device such as a compact thermoelectric condensing device can be implemented into the air path of the blower to assure that the projected air is not saturated with moisture, as the ambient air of the room can be at a high level of humidity.

The labelling system further comprises a proximity sensor 112 which changes its output status when the edge of an incoming egg is detected. The output signal from said sensor 112 is used by the labelling control system 108 to calculate the current speed of the chain conveyer and assert the position of the next egg to be labelled. That information determines when the signal is sent to the labelling device to present a label to the passing egg and at what speed the label shall be advanced to match the egg speed. Thereby, the label is applied to the egg surface with negligible differential speed so that no significant force has to be exerted by the egg to pull the label. Adhesion can thus be reliably performed with no slipping or dragging and the label be accurately positioned on the egg surface. In a simplified embodiment of the system, the output of proximity sensor 112 is directly connected to the trigger of the labelling device and the sensor 112 is positioned so that the time delay required by the egg to move from that position the labelling position matches the delay of response (natural or implemented adjustable delay) of the labelling device.

Turning now more specifically to FIG. 2, it can be seen that data lines 210 and 211 allow communication between packing controller 207 and two ink jet printers 208, 209, as provided in a typical egg grading and packing system such as supplied by Diamond Systems. The data communicated indicates the destination of each egg and whether it should be printed or not. Data input lines 114,115 of the of the interface module 108b of the labelling control system are connected to data lines 210, 211 to pick-up the signal which is interpreted by computer 108a to know the destination of the egg. Said computer is connected to the interface module 108b through cable 117 and said module can be an internal card or an external controller. The destination information from packing controller 207 is used to determine whether a given egg must be labelled or not.

The computer 108a is also used by the operator to indicate the destinations for which eggs are to be labelled and the desired number of labelled eggs per one dozen package in the form of a ratio (ex. 1/1, 1/2, 1/3, 1/4, 1/6, 1/12) which information finally determines what eggs will be labelled. It can also be seen that the proximity sensors 112a, 112b (one upstream each labelling device) are also connected to input ports of the interface module 108b, allowing the computer 108a to evaluate the conveyer speed in real time (based on the strobe frequency and the known pitch of the grippers on the conveyer) and the position of the egg to be printed. In a simplified embodiment of the labelling system, proximity sensors providing a dry contact can be connected directly to their associated labelling device to trigger label ejection according to the position of the egg and the delay of reaction of the labelling device. Blowers 109a, 109b can also be connected to an output of the control system 108 through cables 118,119 and powered when their associated labelling device is operating. Finally, the labelling devices, 100a, 100b, each having an internal controller 113a, 113b are connected to output ports of interface module 108b to allow the computer 108a to automatically set the speed and trigger the cycling of the labelling devices according to the input parameters.

In operation, all of the eggs supported in a gripper of a longitudinal row on the conveyer 201 are following a linear path and eventually contact the smoothing brush 105 of the corresponding labelling device 100. When the computer determines that an egg is to be labelled, upon sensing the presence of said egg with sensor 112 the labelling device is triggered to feed a label at proper speed and time, so that the egg gently catches the label on its path before hitting the brush 105 which conforms itself to the shape of the egg and applies some pressure on the label to secure it to the egg surface. It shall be noted that the only movement performed by the labelling device is advancing the label carrier to peel-off and expose a label at the proper time and speed. Eggs of different sizes, from medium to extra-large, are properly handled by the system since the label hits the egg surface earlier on a larger egg, which only changes the position of the label along the longitudinal axis of the egg. Also, thin plastic labels of a thickness in the order of 0.002 inch are used to facilitate conforming to the shape of the egg surface and prevent formation of ridges, so to provide a uniform surface and neat presentation.

One can easily appreciate that the above described embodiments of the present invention provide an effective solution for the labelling of eggs on a grading and packing line. Therefore, it can be seen that the in-line egg labelling system according to the present invention provides improved features with unmatched economic and functional performance and numerous advantages over the solutions of the prior art.

Although the present invention has been described by means of a preferred embodiment thereof, it is contemplated that various modifications may be made thereto without departing from the spirit and scope of the present invention. Accordingly, it is intended that the embodiment described be considered only as illustrative of the present invention and that the scope thereof should not be limited thereto but be determined by reference to the claims hereinafter provided and their equivalents.

What is claimed is:

1. An in-line egg labelling system for applying a label on eggs travelling into grippers of a conveyer, said system comprising at least one labelling device mounted beneath said conveyor and provided with a label applying arm for applying a label on an exposed area of the surface of said eggs.

2. An in-line egg labelling system as recited in claim 1, wherein said exposed egg surface area is facing generally downwards.

3. An in-line egg labelling system as recited in claim 1 wherein said conveyer is part of an egg packing and grading system comprising a controller and wherein each travelling egg has a destination.

4. An in-line egg labelling system as recited in claim 3 further comprising a computerised labelling control system and a user interface for the automatic individual selection of the eggs to be labelled on the basis of at least one user set parameter and at least one input parameter communicated by said controller.

5. An in-line egg labelling system as recited in claim 4, wherein said at least one input parameter indicates a destination for each travelling egg.

6. An in-line egg labelling system as recited in claim 4, where in s aid at least one user set parameter comprises a parameter specifying for which destinations eggs are to be labelled.

7. An in-line egg labelling system as recited in claim 4, wherein said at least one user set parameter comprises a first parameter specifying for which destinations eggs are to be labelled, and a second parameter specifying a desired ratio for the number of labelled eggs/number of packed eggs at a destination.

8. An in-line egg labelling system as recited in claim 4, wherein said labelling control system and interface further perform generation and output of statistical data about labelling activities carried out by the labelling system.

9. An in-line egg labelling system as recited in claim 1, further comprising at least one sensing device for travelling egg position monitoring.

10. An in-line egg labelling system as recited in claim 1, further comprising an egg surface drying device.

11. An in-line egg labelling system as recited in claim 10, wherein said drying device comprises an air stream generating device.

12. An in-line egg labelling system as recited in claim 1, wherein said labelling system further comprises at least one label smoothing device for applying a slight pressure on applied labels to promote adhesion and proper conforming of labels to egg surfaces.

13. An in-line egg labelling system as recited in claim 12, wherein said label smoothing device comprises a brush member.

14. An in-line egg labelling system as recited in claim 12, wherein said label smoothing device comprises a roller member.

15. An in-line egg labelling system as recited in claim 12, wherein said label smoothing device comprises at least one air jet.

16. An in-line egg labelling system as recited in claim 1, wherein said conveyer comprises two parallel longitudinal rows of grippers and said labelling system comprises two labelling devices, each one being dedicated to the labelling of eggs transported by a specific row of grippers.

17. An in-line egg labelling system as recited in claim 1, wherein said conveyer comprises three parallel longitudinal rows of grippers and said labelling system comprises three labelling devices, each one being dedicated to the labelling of eggs transported by a specific row of grippers.
